(19) United States
(12) Patent Application Publication
(10) Pub. No.: US 2025/0049047 A1
(43) Pub. Date: Feb. 13, 2025

(54) Faye's Pizza on an Edible Stick

(71) Applicant: Roland H Waller, Carol Stream, IL (US)

(72) Inventor: Roland H Waller, Carol Stream, IL (US)

(21) Appl. No.: 18/366,518

(22) Filed: Aug. 7, 2023

(51) Int. Cl. A21D 13/41

(52) U.S. Cl. CPC A21D 13/41

(57) ABSTRACT

Disclosed is a fully edible, new food item, designed to incorporate all primary ingredients of a traditional pizza, defined commercially as an Italian dish consisting usually of a round, flat base made from wheat-based dough, topped with tomatoes, cheese, and other toppings. The food item comprises of three main components: edible stick for holding pizza, pizza crust, and pizza fill. Disclosed is also an automated machine, and the process of operating said machine, configured to manufacture the food item. The automated machine comprises of three primary functional stations: (1) extruder, (2) end sealer, and (3) stick inserter.

### FIELD OF INVENTION

The present invention relates to the general field of fast food, namely fresh and frozen pizza.

### BACKGROUND OF THE INVENTION

The pizza restaurant industry is an important segment in the restaurant industry in the United States. With consumers dining in, getting takeout, and ordering delivery, pizza restaurant sales reached over 46 billion U.S. dollars in 2020. Pizza restaurant sales have seen almost consistent growth in the U.S. for almost a decade. The number of pizza restaurants in the United States has also been on the rise, increasing by over six thousand units in the last eight years to a high of more than 78 thousand units in 2020.¹ 1 Pizza restaurants in the U.S.-statistics & fact; LINK https://www.statista.com/topics/1610/pizza-delivery-market/driving

The global frozen pizza market size was valued at USD 19.6 billion in 2019 and is expected to grow a compound annual growth rate (CAGR) of 3.2% from 2020 to 2027. With the changing lifestyle and changing food preference among millennials, the young generation, and the working-class population is the key factor the market. Moreover, these frozen products offer convenience and higher shelve life, which, in turn, is expected to fuel market growth over the forecast period. Pizza has gained immense popularity as an iconic dish across the world during the last couple of decades. It is chewy and crispy along and offers an embellishment of marinara and cheese, which has been appreciated across the world and has been liked by people of all ages and ethnicity. Although the food has gained remarkable admiration among diners, the recipe remains complicated until date. Regular frozen pizza was the largest product segment with a market share of more than 40.0% in 2019 and expected to maintain dominance over the forecast period. ² 2 Frozen Pizza Market Size, Share & Trends Analysis Report By Product (Regular, Medium, Large), By Distribution Channel (HoReCa, Offline Sales, Online Sales), By Region, And Segment Forecasts, 2020-2027; LINK https://www.grandviewresearch.com/industry-analysis/frozen-pizza-market

However, a traditional pizza is a relatively large food product, requiring greater amount of storage and careful handing. Also, a traditional pizza is classified as the least portable food product, within the most common fast food categories (e.g. burgers, fries etc.). In fact, a plethora of website have been created for the sole purpose of providing simple instructions on how to eat pizza.

Joe Hanson, of the PBS series, analyzes the basic structure of a pizza, and says that its natural state allows it to go limp causing difficulty in consumption. Hanson references 19th century mathematician Carl Friedrich Gauss to support his pizza argument. Gauss had a theorem he called the Theorema Egregium (“excellent theorem”). Essentially it means that a pizza slice begins flat and has zero Gaussian curvature. Gauss's theorem states that one direction of the slice must always remain flat. This means no matter which way you let it bend, the pizza will have some form of flatness. When a slice goes limp, it points sideways and is more difficult to eat. When one folds a pizza slice, however, it points in the direction of your mouth. Thus, because it's more rigid, the pizza slice is easier to eat.³ 3 The Best Way To Eat Pizza; LINK https://www.foodbeast.com/news/the-best-way-to-eat-pizza-is-scientifically-explained/

The present invention, titled PIZZA ON AN EDIBLE STICK. addresses and resolves the above-defined issue. More specifically, the present invention is small, easy to handle, and its cylindrical in shape make it both packaging and distribution friendly. Moreover, the present invention is fully edible, and it incorporates all primary ingredients of a traditional pizza. The invention showing its three main components, namely: (1) edible stick for holding pizza, (2) pizza crust, and (3) pizza fill. The present invention also disclosed is also an automated machine, and the process of operating said machine, configured to manufacture the food item. The automated machine comprises of three primary functional stations: (1) extruder, (2) end sealer, and (3) stick inserter. When an automated stick inserter is not available the edible stick will be inserted manually. The functional stations are connected by a conveyor, which also transports the finished raw product to a fryer or an oven. The extruder and end sealer can maintain the desired speed of production of at least one item per second, so the stick Inserter must be able to keep up with that speed.

### BRIEF SUMMARY OF THE INVENTION

The following is intended to be a brief summary of the invention and is not intended to limit the scope of the invention:

A food product, comprising an elongated cooked dough crust body formed from an edible dough sheet and having a upper end and a lower end, said cooked dough crust body having an inner cavity that enclosed a food filler concentrically disposed in an axially along said elongated crust body, said elongated crust body having an upper crimped crusted end seal to prevent the escape of the upper portion of the food filler with the lower portion of said food filler sealed on the end. At which point an edible stick is inserted into the product thru the filling till it meets the top of the sealed dough.

The second element that makes the invention unique is the edible stick. The edible stick is ½″ D & 7″ long of which 4″ of the edible stick is inserted into the end of the body of product & 3″ is the edible handle. The stick consists of a baked firm crispy pizza dough crust and contains pizza flavorings similar to those in the filling. Another key element to the invention is the filling contains special bindings so the filling is firm so the stick stays in place throughout the entire eating experience.

The manufacturing of the product is also a part of the invention.

A co-extruder will be used such as the Rheon to manufacture the product whereby a tubing is designed so the pizza dough is extruded through the outer orifice of the tubing. Then, the pizza filling is extruded through the center of the dough. Then, every 4¾″ length the product is cut & crimped.

Then, a special mechanism has been designed whereby the pizza dough crust stick is automatically inserted in one end so 4″ of the pizza dough crust stick is inserted through the entire body of the product whereby 3″ of the pizza dough crust stick is remaining outside the product to function as the edible handle.

### DESCRIPTIVE KEY

1. Edible stick for holding pizza
2. Pizza crust
3. Pizza fill
4. Extruder for coextruding a continuous cylinder of pizza fill surrounded by pizza crust dough
5. End Sealer, which cuts the rope-like product from the extruder into lengths and seals both ends by folding and crimping the crust dough
6. Conveyor for carrying the product between operations and then to the fryer or oven
7. The Stick Inserter, which inserts the edible stick into the pizza product
8. The cylindrical product from the extruder
9. The product from the End Sealer
10. The finished raw product ready for baking or frying
11. The gap between pizza fillings to accommodate the sealing of both ends of the product.
12. The locations of the cuts made in the continuous cylinder by the End sealer
13. The sharp instrument used by the Stick Inserter to make a hole in the pizza crust for insertion of the edible pizza stick

### BRIEF DESCRIPTION OF THE DRAWINGS

The components shown in the drawings are not to scale. In the interest of clarity, some of the components might be shown in a generalized form and could be identified utilizing commercial designations. All components, including its essential features, have been assigned reference numbers that are utilized consistently throughout the descriptive process outlined herein:

FIG. 1 shows a perspective view of the present invention, titled PIZZA ON AN EDIBLE STICK, showing its three main components, namely: (1) edible stick for holding pizza, (2) pizza crust, and (3) pizza fill; in accordance with an exemplary embodiment of the present invention.

FIG. 2 shows a perspective view of the present invention, titled PIZZA ON AN EDIBLE STICK, along with a sectional view (defined herein as Section A-A) across the two main components of the invention pizza crust and pizza filler; in accordance with an exemplary embodiment of the present invention.

FIG. 3 shows an automated machine, configured to manufacture the present invention, PIZZA ON AN EDIBLE STICK, along with a sectional view of the same (defined herein as Section B-B), comprising of three primary functional stations: (1) extruder, (2) end sealer, and (3) stick inserter. More specifically, the figure shows a continuous cylinder of an outer layer of pizza dough with pizza filling, inside is extruded on to a moving conveyor and treated by automatic equipment to convert it to the individual product item of pizza on an edible stick, which is conveyed to a fryer or oven for cooking; in accordance with an exemplary embodiment of the present invention.

### DETAILED DESCRIPTION AND BEST MODE OF IMPLEMENTATION

The following description references to the above-defined drawings and represents only an exemplary embodiment of the invention. It is foreseeable, and recognizable by those skilled in the art, that various modifications and/or substitutions to the invention could be implemented without departing from the scope and the character of the invention:

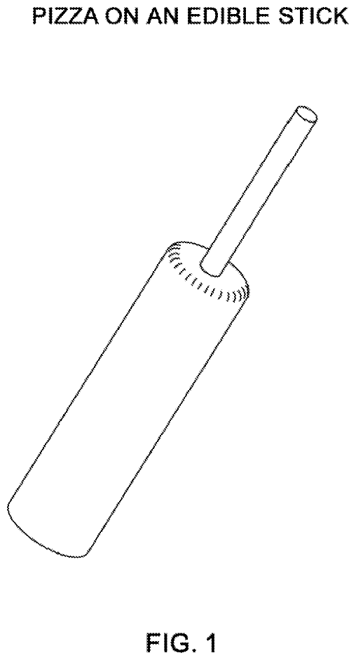

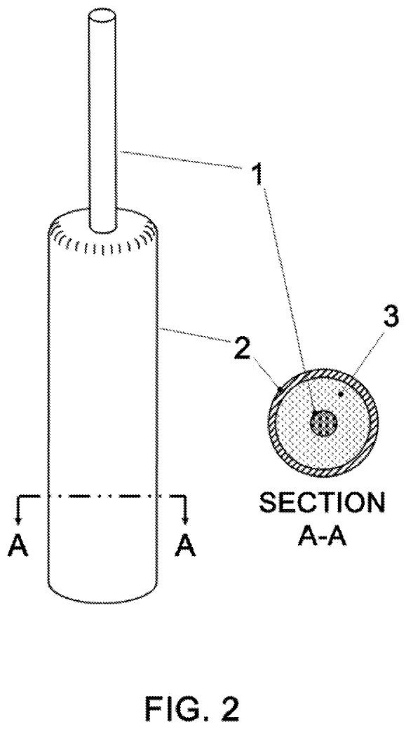

As shown in FIGS. 1 and 2, the claimed invention is a food product, along with an automated system for its manufacturing. The food product comprises of an elongated cooked dough crust body formed from an edible dough sheet and having a upper end and a lower end, said cooked dough crust body having an inner cavity that enclosed a food filler concentrically disposed in an axially along said elongated crust body, said elongated crust body having an upper crimped crusted end seal to prevent the escape of the upper portion of the food filler with the lower portion of said food filler sealed on the end. At which point an edible stick is inserted into the product thru the filling till it meets the top of the sealed dough.

The second element that makes the invention unique is the edible stick. The stick is ½″ D & 7″ long of which 4″ of the stick is inserted into the end of the body of product & 3″ is the edible handle. The stick consists of a baked firm crispy pizza dough crust and contains pizza flavorings similar to those in the filling. Another key element to the invention is the filling contains special bindings so the filling is firm so the stick stays in place throughout the entire eating experience.

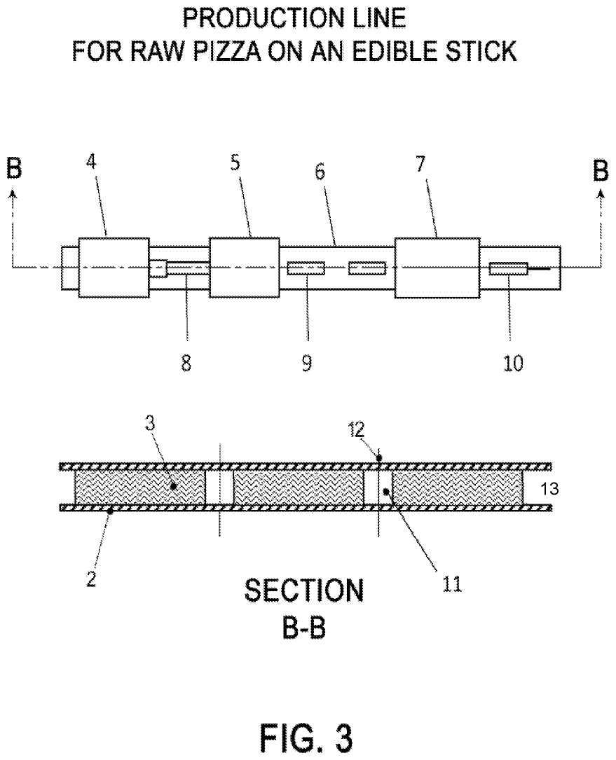

As shown in FIG. 3, the automated system comprises of three main function stations: (1) Extruder, (2) End Sealer and (3) Stick Inserter. A co-extruder will be used such as the Rheon to manufacture the product whereby a tubing is designed so the pizza dough is extruded through the outer orifice of the tubing. Then, the pizza filling is extruded through the center of the dough. Then, every 4¾″ length the product is cut & crimped.

Then, a special mechanism has been designed whereby the pizza dough crust stick is automatically inserted in one end so 4″ of the pizza dough crust stick is inserted through the entire body of the product whereby 3″ of the pizza dough crust stick is remaining outside the product to function as the edible handle.

The product will then be either baked or fried, then frozen and packed 42/5 oz per case for food service (c-stores, vending, etc.) After a success in food service, the product will be offered to retail (12/5 oz per retail package).

More on the automated system shown in FIG. 3. These automated machines are connected by a conveyor, which also transports the finished raw product to a fryer or an oven. The Extruder and End sealer can maintain the desired speed of production of at least one item per second, so the Stick Inserter must be able to keep up with that speed.

The Extruder extrudes a cylinder (about ½ inches in diameter) consisting of the pizza filler enclosed by pizza crust dough. This rope-like extrusion travels a short distance down the conveyor to the End Sealer, which cuts the product in pieces (about 7″ lengths) and seals both ends. To accommodate this process the Extruder leaves gaps in the pizza fill of about 1-inch in length at the places to be cut. The End Sealer cuts the crust dough at the center of these gaps and seals the ends by folding and crimping the extra dough to form a completely enclosed pizza product about 6 inches in length.

The Stick Inserter, which is located a short distance down the conveyor from the End Sealer, carries out two functions: (1) with a very sharp nail-like instrument, it pokes a hole through the crust dough at one end of the product and possibly through most of the length of the pizza fill and then removes the nail and (2) it inserts an edible stick of about ½ inch diameter in the hole formed by the nail. The extra volume occupied by the nail and then the stick causes the outer diameter of the pizza dough to expand by 0.04 inches or about 3%. It is assumed that the product may need external support during these operations.

Also, if more than one second is required for the two-step operation, the Stick Inserter would be required to handle several pizza products simultaneously so that the total output of the machine (and of the entire raw product preparation) is one item per second. An alternate approach is to carry out the steps of (1) making the hole in the crust dough and (2) inserting the edible stick in two separate pieces of equipment. The finished raw product from the Stick Inserter travels down the conveyor to the fryer or oven.

Finally, it should be noted, that the FIG. 3 focuses on the operations to produce the uncooked product not to describe the design of the equipment; the emphasis is on the product, not the machinery.

1. POES is not only delicious but considerably less messy than a slice of pizza.

2. A 5 oz portion of POES is more nutritious when compared to a slice of pepperoni and 4-cheese pizza.

3. POES is more portable and convenient than a slice of pizza.

4. POES is more fun to handle and eat than a slice of messy pizza, especially with kids.

5. Consumers like food on a stick e.g. corn dogs, popsicles, ice cream etc. POES will be the first pizza on an edible stick offered in the United States.
